(19) United States
(12) Patent Application Publication
(10) Pub. No.: US 2017/0161875 A1
(43) Pub. Date: Jun. 8, 2017

(54) VIDEO RESOLUTION METHOD AND APPARATUS

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Fulun TAN, Beijing (CN)

(73) Assignees: LE HOLDINGS (BEIJING) CO., LTD., Beijing (CN); LE SHI INTERNET INFORMATION & TECHNOLOGY CORP., BE IJING, Beijing (CN)

(21) Appl. No.: 15/243,080

(22) Filed: Aug. 22, 2016

Related U.S. Application Data
(63) Continuation of application No. PCT/CN2016/089548, filed on Jul. 10, 2016.

(30) Foreign Application Priority Data
Dec. 4, 2015 (CN) 201510886193.X

(51) Int. Cl. G06T 3/40; G06T 7/00

(52) U.S. Cl. CPC G06T 3/4053; G06T 7/0085; G06T 3/403; G06T 2207/10024; G06T 2207/10016; G06T 2207/20192

(57) ABSTRACT

Disclosed a method and electronic device for improving definition of a video. The method includes: performing edge extraction on an original image frame in the video; and superimposing an image frame obtained after the edge extraction on the original image frame to obtain a new image frame, where the new image frame forms the video. For a standard-definition video, improvement in definition is relatively prominent, so that a viewer can view a video of greater definition with less traffic consumed.

### CROSS-REFERENCE TO RELATED APPLICATIONS

The present disclosure is a continuation of PCT application No. PCT/CN2016/089548 submitted on Jul. 10, 2016, which is based upon and claims priority to Chinese Patent Application No. 201510886193.X, filed on Dec. 4, 2015 and entitled “METHOD AND DEVICE FOR IMPROVING DEFINITION OF VIDEO,” both of which are incorporated herein by reference in their entireties.

### TECHNICAL FIELD

The present disclosure relates to the field of video processing, and specifically, to a method and electronic device for improving definition of a video.

### BACKGROUND

At present, video resolutions are classified into standard definition, high definition, and ultra-high definition in the video industry, wherein the standard definition is a video format having a physical resolution below 720p. Watching or downloading a high-definition video or an ultra-high-definition video consumes more traffic than watching or downloading a standard-definition video, but a standard-definition video has lower definition than that of a high-definition video and ultra-high-definition video. As for users, they are more willing to watch a video that has higher picture definition while consuming less traffic.

Generally, an improvement in the definition of a video is implemented mainly by improving the resolution of the video, which, however, again inevitably increases the amount of traffic consumed for the video.

### SUMMARY

An objective of the present disclosure is to provide a method and electronic device for improving definition of a video, so as to improve definition of a video without changing a resolution of the video.

To implement the foregoing objective, an embodiment of the present disclosure provides a method for improving definition of a video. The method includes: performing edge extraction on an original image frame in the video; and superimposing an image frame obtained after the edge extraction on the original image frame to obtain a new image frame, where the new image frame forms the video.

An embodiment of the disclosure further provides a non-transitory computer-readable storage medium, which stores computer-readable executable instructions, where the computer-readable executable instructions are used to execute any of the foregoing methods for improving definition of a video of the present disclosure.

An embodiment of the disclosure further provides an electronic device for improving definition of a video, including: at least one processor; and a memory in communication connection with the at least one processor, where the memory stores a program that can be executed by the at least one processor, and the instructions are executed by the at least one processor, so that the at least one processor can execute any of the foregoing methods for improving definition of a video of present disclosure.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 shows a flowchart of a method for improving definition of a video according to an embodiment of the present disclosure;

FIG. 2(a) to FIG. 2(c) show a schematic diagram using a method for improving definition of a video according to an embodiment of the present disclosure;

FIG. 3 shows a structural block diagram of a device for improving definition of a video according to an embodiment of the present disclosure; and

FIG. 4 shows a schematic structural diagram of hardware of an electronic device for executing a method for improving definition of a video according to an embodiment of the present disclosure.

### DETAILED DESCRIPTION

Specific implementation manners of the present disclosure are described in detail with reference to accompanying drawings in the following. It should be understood that the specific implementation manners described herein are only for the purpose of specifying and explaining the embodiments of the present disclosure and not intended to limit the embodiments of the present disclosure.

FIG. 1 shows a flowchart of an embodiment of a method for improving definition of a video according to an embodiment of the present disclosure. As shown in FIG. 1, this embodiment of the present disclosure provides a method for improving definition of a video. The method includes: performing edge extraction on an original image frame in the video (step S10); and superimposing an image frame obtained after the edge extraction on the original image frame to obtain a new image frame (step S20), where the new image frame forms the video. The method can improve definition of a video by improving definition of an edge included in each image frame, instead of changing resolution of the video to improve definition.

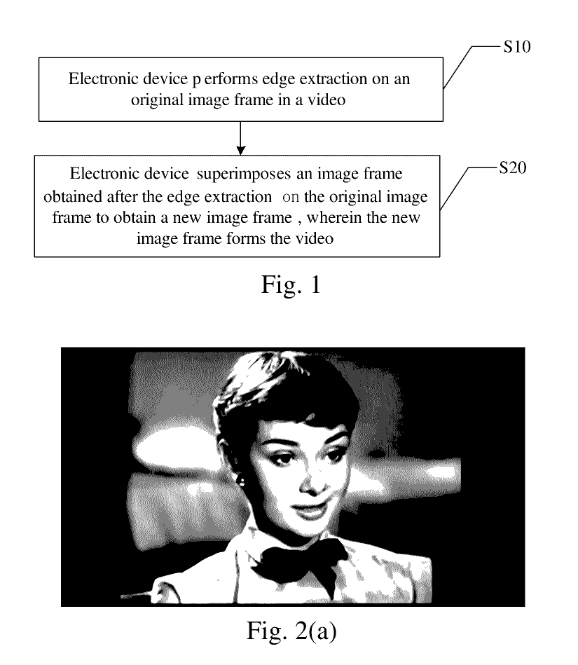

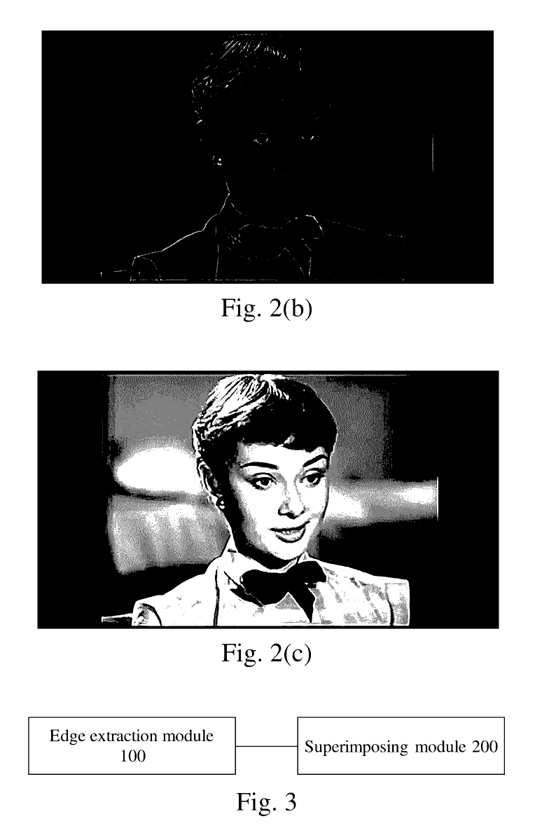

FIG. 2(a) to FIG. 2(c) show a schematic diagram of an embodiment using a method for improving definition of a video according to an embodiment of the present disclosure. FIG. 2(a) is an image frame in an original video. FIG. 2(b) is an image after the image in FIG. 2(a) undergoing edge extraction. FIG. 2(c) is a new image frame formed by overlaying FIG. 2(b) on FIG. 2(a). It can be seen from FIG. 2(c) that definition of the new image frame FIG. 2(c) after superimposing is prominently greater than that of the original image frame FIG. 2(a).

In step S10, an RGB value of pixels included in the image frame after the edge extraction and an RGB value of pixels included in the original image frame may be superimposed respectively. During superimposing, three values R (red), G (green), and B (blue) are superimposed respectively. Because ranges of the three values R (red), G (green), and B (blue) corresponding to each pixel are all from 0 to 255, in this case, it may occur that values of R (red), G (green), and B (blue) corresponding to multiple pixels are all superimposed to 255, that is, a color of this pixel is white. Therefore, though definition of a video is improved by respectively superimposing the RGB value of the pixels included in each image frame after the edge extraction and the RGB value of the pixels included in the original image frame, it may cause that multiple white points occur in a video display picture, and affect quality of the video.

In an embodiment, the RGB value of the pixels included in the image frame after the edge extraction and the RGB value of the pixels included in the original image frame may respectively undergo a weighted superimposition, so as to overcome the disadvantage in the foregoing implementation manner that multiple white points may occur in the video display picture.

An R value of an edge pixel is used as an example for description. The R value of the pixel in the original image is recorded as R1, the R value of the pixel after the edge extraction is recorded as R2, and the R value of the pixel after the weighted superimposition is recorded as R3. During the weighted superimposition, R1 may multiply a coefficient k1 less than 1, R2 may multiply a coefficient k2 less than 1, and then the superimposition is performed. The R value of the pixel after the weighted superimposition is R3=k1*R1+k2*R2. Correspondingly, similar weighted superimpositions may be performed on the G value and the B value of the pixel, and such type of a weighted superimposition may also be applied to all the extracted edge pixels.

Selection of appropriate values of the coefficients k1 and k2 may as far as possible prevent the white points from occurring in the video display picture after the superimposition, thereby further improving the quality of the video and subjective visual experience of a viewer.

In an implementation manner, the coefficient k1 may be equal to 0, that is, during the weighted superimposition, the RGB value of the edge pixel in the original image is not changed, and only the RGB value of the edge pixel in an image after the edge extraction is changed. An R value of an edge pixel is used as an example for description. The R value of the pixel after the weighted superimposition is R3=R1+k2*R2. Correspondingly, similar weighted superimpositions may be performed on the G value and the B value of the pixel, and such type of a weighted superimposition may be applied to all the extracted edge pixels. However, this embodiment of the present disclosure is not limited thereto, and in other implementation manners, the values of the coefficients k1 and k2 may be set as required, thereby ensuring definition of a video.

In superimposition, in the embodiments of the present disclosure, the edge extraction may be performed on the original image frame in the video by one or more of the following: a Roberts edge detection operator, a Sobel edge detection operator, a Prewitt edge operator, a Laplacian of Gaussian operator, a Canny operator, or the like, but the embodiments of the present disclosure are not limited thereto. An edge detection operator used in the embodiments of the present disclosure may be any edge detection operator well known in the art. In a specific implementation manner, various edge detection operators may be selected by comparing display effects of videos after superimposing.

FIG. 3 shows a structural block diagram of an embodiment of a device for improving definition of a video according to an embodiment of the present disclosure. As shown in FIG. 3, correspondingly, this embodiment of the present disclosure further provides a device for improving definition of a video. The device may include: an edge extraction module 100 configured to perform edge extraction on an original image frame in the video; and a superimposing module 200 configured to superimposing an image frame obtained after the edge extraction on the original image frame to obtain a new image frame, where the new image frame forms the video.

In an embodiment, the superimposing module 100 may be further configured to respectively superimposing an RGB value of pixels included in the image frame obtained after the edge extraction and an RGB value of corresponding pixels in the original image frame. In an embodiment, the superimposing module 100 may be further configured to perform a weighted superimposition of the RGB value of the pixels included in the image frame obtained after the edge extraction and the RGB value of the corresponding pixels in the original image frame.

In superimposition, the edge extraction module is configured to perform edge extraction on the original image frame in the video by at least one of the following methods: a Roberts edge detection operator, a Sobel edge detection operator, a Prewitt edge operator, a Laplacian of Gaussian operator, or a Canny operator.

Principles and benefits of the device for improving definition of a video provided by the embodiments of the present disclosure are similar to those of the above method for improving definition of a video, which are not described herein repeatedly.

Correspondingly, an embodiment of the present disclosure further provides a video player, where the video player includes the above device for improving definition of a video.

Different viewers have different sensitivity to definition of a video, and therefore, multiple selections for improving the definition of the video are provided for the viewers in the video player. For example, for the same video, some classical values of coefficients k1 and k2 may be set, and selections corresponding to the values are displayed on the video player; and/or for the same video, different edge extraction operators may be set, and the selections are displayed on the video player, so that the viewers may select a satisfactory video effect according to their own subjective feelings.

According to the method and the device for improving definition of a video provided by the embodiments of the present disclosure, for a standard-definition video, improvement in definition is relatively prominent, so that a viewer can view a video of greater definition with less traffic consumed.

An embodiment of the disclosure provides a non-transitory computer-readable storage medium, which stores computer-readable executable instructions, where the computer-readable executable instructions can execute the method for improving definition of a video of any of the foregoing method embodiments of the present disclosure.

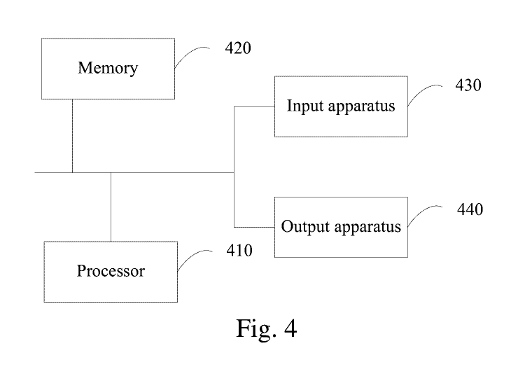

FIG. 4 is a schematic structural diagram of hardware of an electronic device for executing a method for improving definition of a video provided by an embodiment of the disclosure. As shown in FIG. 4, the electronic device includes: one or more processors 410 and a memory 420, with one processor 410 as an example in FIG. 4.

A device for executing the method for improving definition of a video may further include: an input apparatus 430 and an output apparatus 440.

The processor 410, the memory 420, the input apparatus 430, and the output apparatus 440 can be connected by means of a bus or in other manners, with a connection by means of a bus as an example in FIG. 4.

As a non-transitory computer-readable readable storage medium, the memory 420 can be used to store non-transitory software programs, non-transitory computer-readable executable programs and modules, for example, program instructions/module corresponding to the method for improving definition of a video in the embodiments of the disclosure (for example, an edge extraction module 100 and an superimposing module 200 shown in FIG. 3). The processor 410 executes various functional disclosures and data processing of the electronic device, that is, implements the method for improving definition of a video of the foregoing method embodiments, by running the non-transitory software programs, instructions, and modules stored in the memory 420.

The memory 420 may include a program storage area and a data storage area, where the program storage area may store an operating system and at least one disclosure needed by function; the data storage area may store data created according to use of the electronic device, and the like. In superimposition, the memory 420 may include a high-speed random access memory, and also may include a non-transitory memory, such as at least one disk storage device, flash storage device, or other non-transitory solid-state storage devices. In some embodiments, the memory 420 optionally includes memories remotely disposed with respect to the processor 410, and the remote memories may be connected, via a network, to the electronic device. Examples of the foregoing network include but are not limited to: the Internet, an intranet, a local area network, a mobile communications network, and a combination thereof.

The input apparatus 430 can receive entered digit or character information, and generate key signal inputs relevant to user setting and functional control of the electronic device. The output apparatus 440 may include a display device, for example, a display screen, etc.

The one or more modules are stored in the memory 420, and execute the method for improving definition of a video in any one of the foregoing method embodiments when being executed by the one or more processors 410.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer-readable, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

What is claimed is:

1. A method for improving definition of a video, applied in an electronic device, comprising:
performing edge extraction on an original image frame in the video, and
superimposing an image frame obtained after the edge extraction on the original image frame to obtain a new image frame, wherein the new image frame forms the video.

2. The method according to claim 1, wherein the superimposing an image frame obtained after the edge extraction on the original image frame comprises:
superimposing an RGB value of pixels comprised in the image frame obtained after the edge extraction and an RGB value of corresponding pixels in the original image frame.

3. The method according to claim 1, wherein the superimposing an image frame obtained after the edge extraction on the original image frame comprises:
Weighting and superimposing an RGB value of pixels comprised in the image frame obtained after the edge extraction and an RGB value of corresponding pixels in the original image frame.

4. The method according to claim 1, wherein the performing edge extraction on the original image frame in the video comprises: performing edge extraction on each image frame in the video by one or more of the following: a Roberts edge detection operator, a Sobel edge detection operator, a Prewitt edge operator, a Laplacian of Gaussian operator, or a Canny operator.

5. An non-transitory computer-readable storage medium, storing with computer-readable executable instructions that, when executed by an electronic device, cause the electronic device to:
perform edge extraction on an original image frame in the video, and
an image frame obtained after the edge extraction on the original image frame to obtain a new image frame, wherein the new image frame forms the video.

6. The non-transitory computer-readable storage medium according to claim 5, wherein the instructions to superimpose an image frame obtained after the edge extraction on the original image frame cause the electronic device to:
an RGB value of pixels comprised in the image frame obtained after the edge extraction and an RGB value of corresponding pixels in the original image frame.

7. The non-transitory computer-readable storage medium according to claim 5, wherein the instructions to superimpose an image frame obtained after the edge extraction on the original image frame cause the electronic device to:
weight and superimpose an RGB value of pixels comprised in the image frame obtained after the edge extraction and an RGB value of corresponding pixels in the original image frame.

8. The non-transitory computer-readable storage medium according to claim 5, wherein the instructions to perform edge extraction on the original image frame in the video cause the electronic device to:
perform edge extraction on each image frame in the video by one or more of the following: a Roberts edge detection operator, a Sobel edge detection operator, a Prewitt edge operator, a Laplacian of Gaussian operator, or a Canny operator.

9. An electronic device, comprising:
at least one processor; and
a memory in communication connection with the at least one processor, where the memory stores a program that can be executed by the at least one processor, wherein execution of the instructions by the at least one processor causes the at least one processor to:
perform edge extraction on an original image frame in the video, and
an image frame obtained after the edge extraction on the original image frame to obtain a new image frame, wherein the new image frame forms the video.

10. The electronic device according to claim 9, wherein the execution of the instructions to superimpose an image frame obtained after the edge extraction on the original image frame causes the at least one processor to:
an RGB value of pixels comprised in the image frame obtained after the edge extraction and an RGB value of corresponding pixels in the original image frame.

11. The electronic device according to claim 9, wherein the execution of the instructions to superimpose an image frame obtained after the edge extraction on the original image frame causes the at least one processor to:
weight and superimpose an RGB value of pixels comprised in the image frame obtained after the edge extraction and an RGB value of corresponding pixels in the original image frame.

12. The electronic device according to claim 9, wherein the execution of the instructions to perform edge extraction on the original image frame in the video causes the at least one processor to: perform edge extraction on each image frame in the video by one or more of the following: a Roberts edge detection operator, a Sobel edge detection operator, a Prewitt edge operator, a Laplacian of Gaussian operator, or a Canny operator.
